(19) United States
(12) Patent Application Publication
(10) Pub. No.: US 2012/0236915 A1
(43) Pub. Date: Sep. 20, 2012

(54) CROSSTALK CONTROL METHODS AND APPARATUS UTILIZING COMPRESSED REPRESENTATION OF COMPENSATION COEFFICIENTS

(76) Inventor: Carl J. Nuzman, Union, NJ (US)

(21) Appl. No.: 13/051,407

(22) Filed: Mar. 18, 2011

(51) Int. Cl. H04B 17/00

(52) U.S. Cl. 375/224

(57) ABSTRACT

An access node of a communication system is configured to control crosstalk between channels of the system. Vectoring circuitry in the access node is configured to determine estimates of crosstalk from one channel of the system into another channel of the system on multiple sub-channels, to determine compensation coefficients for respective ones of the multiple sub-channels based on the crosstalk estimates, and to generate compensated signals for respective ones of the multiple sub-channels based on the compensation coefficients. At least a given one of the compensation coefficients is determined for use in the generation of compensated signals by decompressing a compressed representation of the given compensation coefficient. The compressed representation is decompressed by evaluating a parameterized function of a plurality of control parameters at least one of which does not correspond to any of the compensation coefficients. The compensated signals may be pre-compensated signals or post-compensated signals.

### FIELD OF THE INVENTION

The present invention relates generally to communication systems, and more particularly to techniques for mitigating, suppressing or otherwise controlling interference between communication channels in such systems.

### BACKGROUND OF THE INVENTION

Multi-channel communication systems are often susceptible to interference between the various channels, also referred to as crosstalk or inter-channel crosstalk. For example, digital subscriber line (DSL) broadband access systems typically employ discrete multi-tone (DMT) modulation over twisted-pair copper wires. One of the major impairments in such systems is crosstalk between multiple subscriber lines within the same binder or across binders. Thus, signals transmitted over one subscriber line may be coupled into other subscriber lines, leading to interference that can degrade the throughput performance of the system. More generally, a given “victim” channel may experience crosstalk from multiple “disturber” channels, again leading to undesirable interference.

Different techniques have been developed to mitigate, suppress or otherwise control crosstalk and to maximize effective throughput, reach and line stability. These techniques are gradually evolving from static or dynamic spectrum management techniques to multi-channel signal coordination.

By way of example, pre-compensation techniques allow active cancellation of inter-channel crosstalk through the use of a precoder. In DSL systems, the use of a precoder is contemplated to achieve crosstalk cancellation for downstream communications between a central office (CO) or another type of access node (AN) and customer premises equipment (CPE) units or other types of network terminals (NTs). It is also possible to implement crosstalk control for upstream communications from the NTs to the AN, using so-called post-compensation techniques implemented by a postcoder. Such pre-compensation and post-compensation techniques are also referred to as “vectoring,” and include G.vector technology, which was recently standardized in ITU-T Recommendation G.993.5.

One known approach to estimating crosstalk coefficients for downstream or upstream crosstalk cancellation in a DSL system involves transmitting distinct pilot signals over respective subscriber lines between an AN and respective NTs of the system. Error feedback from the NTs based on the transmitted pilot signals is then used to estimate crosstalk. Other known approaches involve perturbation of precoder coefficients and feedback of signal-to-noise ratio (SNR) or other interference information.

Multiple subscriber lines that are subject to pre-compensation or post-compensation for crosstalk cancellation in a DSL system may be referred to as a vectoring group. In conventional DSL systems, the number of lines in a vectoring group is subject to practical limitations based on the processor and memory resources required to perform pre-compensation or post-compensation operations. Such operations include the computation of matrix-vector products using precoder and postcoder matrices, respectively. If there are N lines in the vectoring group, the precoder matrix or postcoder matrix associated with a particular subcarrier, or tone, is typically of dimension N×N. For example, a given matrix-vector product computed in the precoder may be given by y=Cx, where y is an N×1 vector of pre-compensated signals, x is a corresponding N×1 vector of signals prior to pre-compensation, and C is the N×N precoder matrix. The number of entries in the precoder matrix thus increases as the square of the number of lines N in the vectoring group.

The precoder matrix C is ideally the inverse of the channel matrix of the system, and therefore must be updated as the channel crosstalk characteristics change, for example, in conjunction with channel activation or deactivation. Ideally the updates should converge quickly to the ideal values. Also, transient events such as activation or deactivation should not cause problems on lines that are not involved in the transient events. For example, an active line should not experience errors when a neighboring line activates or deactivates.

As indicated above, there is typically a separate precoder or postcoder matrix associated with each tone of a given DSL system. Such matrices are also generally referred to herein as compensation matrices. In a brute force vectoring approach, in a system with N lines, one would store in a memory an array of N² coefficients to represent the compensation matrix to be used on a given tone. If the system utilizes K tones on each of the N lines, the memory would be required to have a capacity sufficient to store N²K coefficients. As it is not unusual for a given system to have hundreds of lines and thousands of tones, the hardware requirements associated with storing the compensation matrices can be excessive.

In typical scenarios of interest, the compensation matrices are inverse matrices of channel matrices. The channel matrices themselves are not independent from tone to tone. Instead, the channel matrix coefficients often vary smoothly as a function of tone index. In such cases, the desired compensation matrix also varies smoothly. This means there is redundancy, and therefore an opportunity to generate reduced representations of the compensation matrices with fewer coefficients.

One known approach involves storing only a relatively small number of coefficients, and generating the rest “on the fly” by interpolation. For example, one can use piecewise constant interpolation. In this technique, given a downsampling factor D, one only stores N²K/D coefficients. The first compensation matrix is used for the first D tones, then the second compensation matrix is used for the next D tones, and so on. For higher accuracy when the coefficients change more rapidly as a function of tone, one can use piecewise linear interpolation. Here, linear interpolation between the first two matrices is used for the first D tones, then linear interpolation between the second and third matrices is used for the second group of D tones, and so on.

The above-described piecewise constant or linear interpolation techniques generally work well if the channels are sufficiently slow varying. However, there are cases where these techniques do not work particularly well. For example, in systems with non-standard network topologies, such as those which include bridged taps, the crosstalk channels can change more rapidly as a function of frequency than is the case in “normal” topologies. In such cases, simple piecewise constant or linear interpolation techniques give poor performance with high subsampling values D, or equivalently, they require that small D values be used in order to maintain acceptable crosstalk control performance. Higher order interpolation techniques, such as cubic spline interpolation or transform-based interpolation, require significant amounts of computation in order to derive intermediate channel values from the subsampled channel, and can also be adversely affected by measurement noise. Moreover, these higher order interpolation techniques generally require global access to substantially all tone frequencies, as opposed to piecewise constant or linear interpolation which is based purely on local information.

### SUMMARY OF THE INVENTION

Illustrative embodiments of the invention provide improved techniques for generating pre-compensated or post-compensated signals for controlling crosstalk between channels of a communication system. For example, in one or more of these embodiments, a precoder or postcoder implemented at least in part by a vector processor utilizes compressed representations of compensation coefficients in which a given such coefficient is represented as a parameterized function of a plurality of control parameters at least one of which does not correspond to any of the compensation coefficients.

In one aspect of the invention, an access node of a communication system is configured to control crosstalk between channels of the system. The access node may comprise, for example, a DSL access multiplexer of a DSL system. Vectoring circuitry in the access node is configured to determine estimates of crosstalk from one channel of the system into another channel of the system on multiple sub-channels, to determine compensation coefficients for respective ones of the multiple sub-channels based on the crosstalk estimates, and to generate compensated signals for respective ones of the multiple sub-channels based on the compensation coefficients. At least a given one of the compensation coefficients is determined for use in the generation of compensated signals by decompressing a compressed representation of the given compensation coefficient. The compressed representation is decompressed by evaluating a parameterized function of a plurality of control parameters at least one of which does not correspond to any of the compensation coefficients. The compensated signals may be pre-compensated signals or post-compensated signals.

One or more of the illustrative embodiments overcome the problems associated with the above-noted conventional techniques such as interpolation. For example, a given one of the illustrative embodiments can provide improved crosstalk control in the presence of rapid channel variations, and in non-standard network topologies, while avoiding the excessive computation requirements and measurement noise issues associated with conventional higher order interpolation techniques. Thus, a given DSL system can support larger groups of vectored lines than would otherwise be possible using available memory and computational resources.

These and other features and advantages of the present invention will become more apparent from the accompanying drawings and the following detailed description.

### BRIEF DESCRIPTION OF THE DRAWINGS

FIG. 1 is a block diagram of a multi-channel communication system in an illustrative embodiment of the invention.

FIG. 2 shows an exemplary DSL implementation of the FIG. 1 communication system in an illustrative embodiment.

FIG. 3 shows a more detailed view of one possible implementation of a portion of a DSL access multiplexer of the FIG. 2 system.

FIGS. 4A, 4B and 4C show examples of respective linear, quadratic and cubic spline function based compressed representations of compensation coefficients in illustrative embodiments of the invention.

FIGS. 5, 6 and 7 are flow diagrams of respective offline preparation, vector processing and offline update portions of a process for generation and utilization of compressed representations of compensation coefficients in illustrative embodiments of the invention.

### DETAILED DESCRIPTION OF THE INVENTION

The present invention will be illustrated herein in conjunction with exemplary communication systems and associated techniques for crosstalk control in such systems. The crosstalk control may be applied substantially continuously, or in conjunction with activating or deactivating of subscriber lines or other communication channels in such systems, tracking changes in crosstalk over time, or in other line management applications. It should be understood, however, that the invention is not limited to use with the particular types of communication systems and crosstalk control applications disclosed. The invention can be implemented in a wide variety of other communication systems, and in numerous alternative crosstalk control applications. For example, although illustrated in the context of DSL systems based on DMT modulation, the disclosed techniques can be adapted in a straightforward manner to a variety of other types of wired or wireless communication systems, including cellular systems, multiple-input multiple-output (MIMO) systems, Wi-Fi or WiMax systems, etc. The techniques are thus applicable to other types of orthogonal frequency division multiplexing (OFDM) systems outside of the DSL context, as well as to systems utilizing higher order modulation in the time domain.

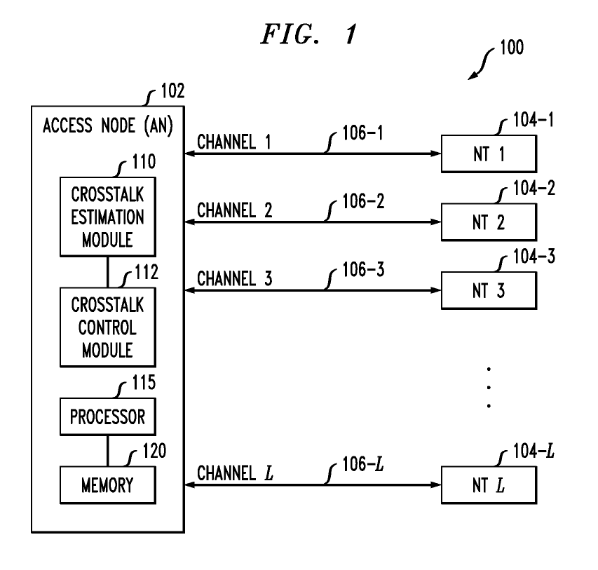

FIG. 1 shows a communication system 100 comprising an access node (AN) 102 and network terminals (NTs) 104. The NTs 104 more particularly comprise L distinct NT elements that are individually denoted NT 1, NT 2, . . . NT L, and are further identified by respective reference numerals 104-1, 104-2, . . . 104-L as shown. A given NT element may comprise, by way of example, a modem, a computer, or other type of communication device, or combinations of such devices. The access node 102 communicates with these NT elements via respective channels 106-1, 106-2, . . . 106-L, also denoted Channel 1, Channel 2, . . . Channel L.

As indicated previously herein, in an embodiment in which system 100 is implemented as a DSL system, the AN 102 may comprise, for example, a central office (CO), and the NTs 104 may comprise, for example, respective instances of customer premises equipment (CPE) units. The channels 106 in such a DSL system comprise respective subscriber lines. Each such subscriber line may comprise, for example, a twisted-pair copper wire connection. The lines may be in the same binder or in adjacent binders, such that crosstalk can arise between the lines. Portions of the description below will assume that the system 100 is a DSL system, but it should be understood that this is by way of example only.

In an illustrative DSL embodiment, fewer than all of the L lines 106-1 through 106-L may be initially active lines, and at least one of the L lines may be a “joining line” that is to be activated and joined to an existing set of active lines. Such a joining line is also referred to herein as an “activating line.” As indicated previously, a given set of lines subject to crosstalk control may be referred to herein as a vectoring group.

Communications between the AN 102 and the NTs 104 include both downstream and upstream communications for each of the active lines. The downstream direction refers to the direction from AN to NT, and the upstream direction is the direction from NT to AN. Although not explicitly shown in FIG. 1, it is assumed without limitation that there is associated with each of the subscriber lines of system 100 an AN transmitter and an NT receiver for use in communicating in the downstream direction, and an NT transmitter and an AN receiver for use in communicating in the upstream direction. A given module combining an AN transmitter and an AN receiver, or an NT transmitter and an NT receiver, is generally referred to herein as a transceiver. The corresponding transceiver circuitry can be implemented in the AN and NTs using well-known conventional techniques, and such techniques will not be described in detail herein.

The AN 102 in the present embodiment comprises a crosstalk estimation module 110 coupled to a crosstalk control module 112. The AN utilizes the crosstalk estimation module to obtain estimates of crosstalk between respective pairs of at least a subset of the lines 106. The crosstalk estimates may also be referred to as crosstalk channel coefficients or simply crosstalk coefficients. The crosstalk control module 112 is used to mitigate, suppress or otherwise control crosstalk between at least a subset of the lines 106 using compensation coefficients that are determined based on the crosstalk estimates. For example, the crosstalk control module may be utilized to provide pre-compensation of downstream signals transmitted from the AN to the NTs, and additionally or alternatively post-compensation of upstream signals transmitted from the NTs to the AN.

The crosstalk estimation module 110 may be configured to generate crosstalk estimates from error samples, SNR values or other types of measurements generated in the AN 102 based on signals received from the NTs 104, or measurements generated in the NTs 104 and fed back to the AN 102 from the NTs 104. It should be noted that the term SNR as used herein is intended to be broadly construed so as to encompass other similar measures, such as signal-to-interference-plus-noise ratios (SINRs).

In other embodiments, crosstalk estimates may be generated outside of the AN 102 and supplied to the AN for further processing. For example, such estimates may be generated in the NTs 104 and returned to the AN for use in pre-compensation, post-compensation, or other crosstalk control applications.

The crosstalk estimation module 110 may incorporate denoising functionality for generating denoised crosstalk estimates. Examples of crosstalk estimate denoising techniques suitable for use with embodiments of the invention are described in U.S. Patent Application Publication No. 2010/0177855, entitled “Power Control Using Denoised Crosstalk Estimates in a Multi-Channel Communication System,” which is commonly assigned herewith and incorporated by reference herein. It is to be appreciated, however, that the present invention does not require the use of any particular denoising techniques. Illustrative embodiments to be described herein may incorporate denoising functionality using frequency filters as part of a channel coefficient estimation process.

The AN 102 further comprises a processor 115 coupled to a memory 120. The memory may be used to store one or more software programs that are executed by the processor to implement the functionality described herein. For example, functionality associated with crosstalk estimation module 110 and crosstalk control module 112 may be implemented at least in part in the form of such software programs. The memory is an example of what is more generally referred to herein as a computer-readable storage medium that stores executable program code. Other examples of computer-readable storage media may include disks or other types of magnetic or optical media.

It is to be appreciated that the AN 102 as shown in FIG. 1 is just one illustration of an “access node” as that term is used herein. Such an access node may comprise, for example, a DSL access multiplexer (DSLAM). However, the term “access node” as used herein is intended to be broadly construed so as to encompass, for example, a particular element within a CO, such as a DSLAM, or the CO itself, as well as other types of access point elements in systems that do not include a CO.

In the illustrative embodiment of FIG. 1 the lines 106 are all associated with the same AN 102. However, in other embodiments, these lines may be distributed across multiple access nodes. Different ones of such multiple access nodes may be from different vendors. For example, it is well known that in conventional systems, several access nodes of distinct vendors can be connected to the same bundle of DSL lines. Under these and other conditions, the various access nodes may have to interact with one another in order to achieve optimal interference cancellation.

Each of the NTs 104 may be configurable into multiple modes of operation responsive to control signals supplied by the AN 102 over control signal paths, as described in U.S. Patent Application Publication No. 2009/0245081, entitled “Fast Seamless Joining of Channels in a Multi-Channel Communication System,” which is commonly assigned herewith and incorporated by reference herein. Such modes of operation may include, for example, a joining mode and a tracking mode. However, this type of multiple mode operation is not a requirement of the present invention.

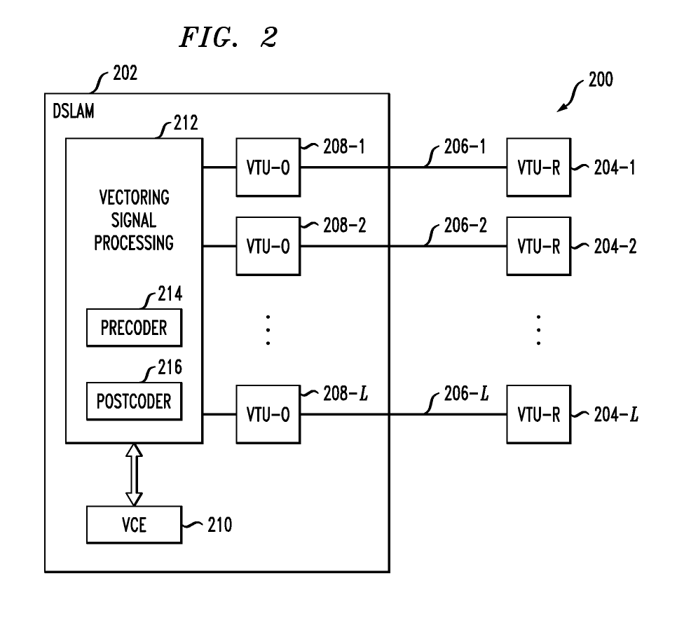

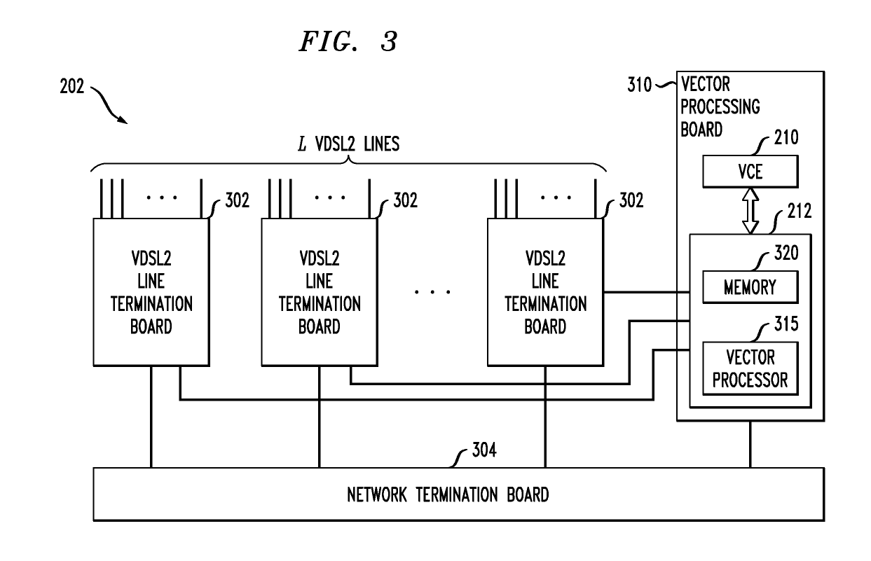

An exemplary DSL implementation of the system 100 of FIG. 1 that is configured to perform at least one of pre-compensation and post-compensation will be described below with reference to FIGS. 2 and 3. More specifically, this implementation includes a precoder providing active crosstalk cancellation for downstream communications from AN 102 to the NTs 104, and also includes a postcoder providing active crosstalk cancellation for upstream communications from the NTs 104 to the AN 102. However, the techniques disclosed herein are applicable to systems involving symmetric communications in which there is no particular defined downstream or upstream direction.

Referring now to FIG. 2, vectored DSL system 200 represents a possible implementation of the multi-channel communication system 100 previously described. A DSLAM 202 in an operator access node connects to a plurality of CPE units 204 via respective copper twisted pair lines 206 that may be in a common binder. The CPE units 204 more specifically comprise remote VDSL transceiver units (VTU-Rs) 204-1, 204-2, . . . 204-L. These VTU-Rs communicate with respective operator-side VDSL transceiver units (VTU-Os) 208-1, 208-2, . . . 208-L. The DSLAM 202 further comprises a vector control entity (VCE) 210 and a vectoring signal processing module 212. The vectoring signal processing module 212 comprises a precoder 214 and a postcoder 216. The VCE 210 and vectoring signal processing module 212 may be viewed as corresponding generally to crosstalk estimation module 110 and crosstalk control module 112 of system 100. Such elements are considered examples of what is more generally referred to herein as “vectoring circuitry.”

In the FIG. 2 embodiment, it is assumed without limitation that the VTU-Rs 204 and corresponding VTU-Os 208 operate in a manner compliant with a particular vectoring standard, and more specifically the G.vector standard disclosed in ITU-T Recommendation G.993.5, “Self-FEXT cancellation (vectoring) for use with VDSL2 transceivers,” April 2010, which is incorporated by reference herein. It should be noted that use of this particular standard is by way of illustrative example only, and the techniques of the invention can be adapted in a straightforward manner to other types and arrangements of AN and NT elements suitable for performing vectoring or other similar crosstalk control operations.

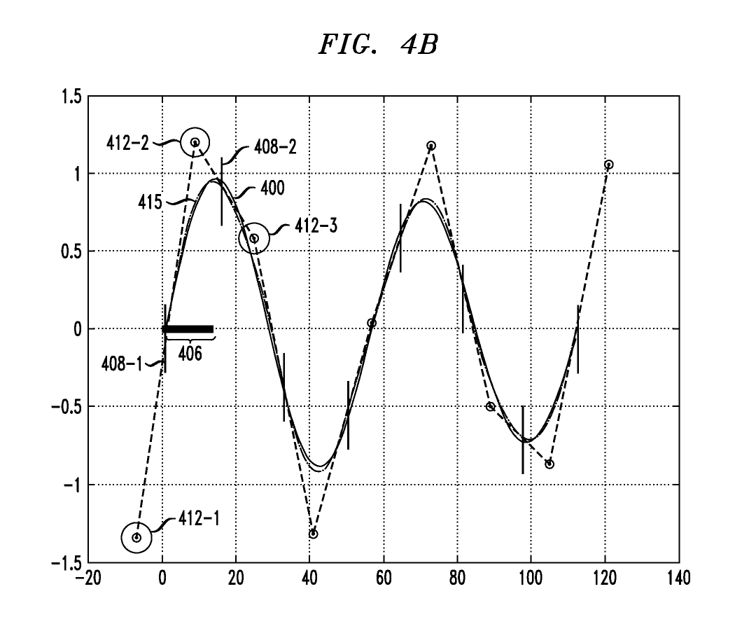

FIG. 3 shows a more detailed view of one possible implementation of a portion of the DSLAM 202 of FIG. 2. In this exemplary implementation, the DSLAM 202 comprises a plurality of VDSL2 line termination boards 302 that are coupled to a network termination board 304 and to a vector processing board 310. The vector processing board 310 includes the VCE 210 and the vectoring signal processing module 212, and may also include additional vectoring circuitry not explicitly shown but commonly included in a conventional implementation of such a vector processing board. The vectoring signal processing module 212 includes vector processor 315 and its associated external memory 320. The operation of the vector processor 315 and other elements of vector processing board 310 will be described in greater detail below in conjunction with FIGS. 5, 6 and 7.

The vector processor 315 can be implemented in a straightforward manner using a single FPGA, such as, for example, an Altera Stratix IV GX or GT FPGA, as would be appreciated by one skilled in the art. Other arrangements of one or more integrated circuits or other types of vectoring circuitry may be used to implement a vector processor and other associated vectoring elements in a given embodiment.

The vectoring signal processing unit 212 in DSLAM 202 is configured under control of the VCE 210 to implement pre-compensation for signals transmitted in the downstream direction and post-compensation for signals received in the upstream direction. Effective implementation of these pre-compensation and post-compensation crosstalk control techniques requires the generation and processing of compensation coefficients. As mentioned previously, the storage and computational requirements associated with use of such coefficients increases as the square of the number of lines and linearly with the number of tones. This has led to the use of downsampling in order to produce a reduced number of subsampled coefficients, with other coefficients being generated as needed by interpolating between the subsampled coefficients. However, as indicated previously, conventional piecewise constant or linear interpolation between subsampled coefficients is problematic in the presence of rapid channel variations or non-standard network topologies, and more complex higher order interpolation techniques require excessive computational resources and can be adversely affected by measurement noise.

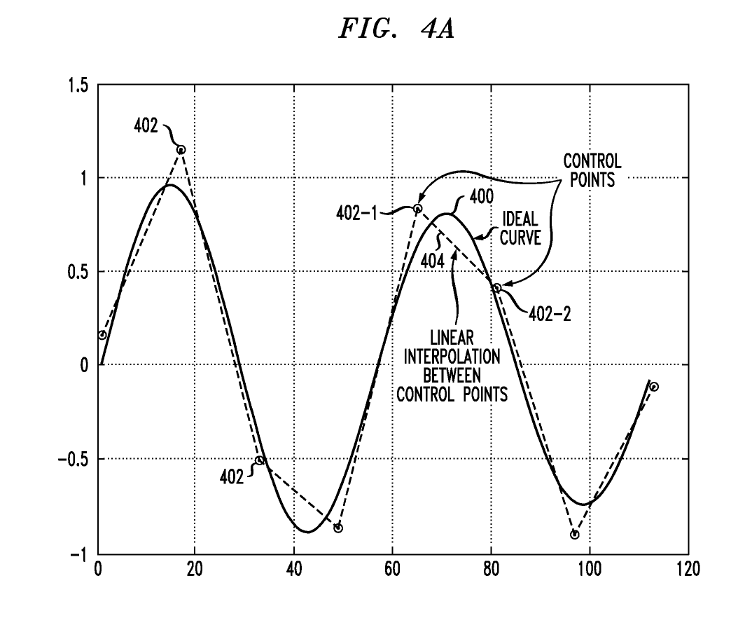

Illustrative embodiments of the present invention overcome these drawbacks of the prior art by generating and processing compressed representations of the compensation coefficients using a parameterized function in which at least a subset of the control points or other control parameters do not correspond to any of the compensation coefficients. For example, these compressed representations may be processed in determining compensation coefficients that may correspond to respective elements of the precoder and postcoder matrices utilized in precoder 214 and postcoder 216, respectively. Examples of compressed representations of compensation coefficients that may be used in crosstalk control will be described below in conjunction with FIGS. 4A, 4B and 4C.

The illustrative embodiments therefore utilize compressed representations for the compensation coefficients, rather than subsampled coefficients. By way of example, let C_{n,m}(k) denote a particular compensation coefficient as a function of tone k. The compensation coefficient function C_{n,m}(k) is typically a complex sequence. The compensation coefficient at each tone k is an element of a corresponding compensation matrix C that in this example is assumed to have dimension N×M, where n=1, . . . N and m=1, . . . M. The compensation matrix C may be, for example, a precoder matrix or a postcoder matrix.

Instead of representing the sequence C_{n,m}(k) using subsampled coefficients C_{n,m}(0), C_{n,m}(D), C_{n,m}(2D) . . . , the sequence is represented using control parameters which may be in the form of a vector p=p(0), p(D), p(2D) . . . , where the control parameters do not necessarily correspond to any particular subsampled coefficient(s). The control parameters are chosen in combination with a parameterized function ƒ(k,p) that provides a sufficiently good approximation to the original sequence C_{n,m}(k). The parameterized function ƒ(k,p) should have low complexity, that is, it should be easy to compute a given compensation coefficient C_{n,m}(k) for a particular tone k using a subset of the control parameters p. The parameterized function ƒ(k,p) should also have a locality property, that is, the given compensation coefficient C_{n,m}(k) for a particular tone k should only depend on a small number of control parameters close in index to tone k, and not on the entire parameter sequence.

A more particular illustration of a parameterized function ƒ(k,p) having the low complexity and locality properties described above is a spline function, such as a b-spline. In this case, the control parameters comprise respective control points. A b-spline function may be used in one or more of the embodiments to represent the complex sequence C_{n,m}(k) which as indicated above denotes a particular compensation coefficient as a function of tone k. The complex sequence C_{n,m}(k) generally follows a smooth curve, and therefore any particular value on the curve may be calculated efficiently as a weighted combination of a designated number of the control points.

The order of the b-spline function indicates the number of control points that are used to represent each value on the smooth curve. For example, in the case of a first order or linear b-spline function, any given value on the smooth curve may be represented as a weighted combination of its two nearest control points. Similarly, for a second order or quadratic b-spline function, any given value on the smooth curve may be represented as a weighted combination of its three nearest control points, and for a third order or cubic b-spline function, any given value on the smooth curve may be represented as a weighted combination of its four nearest control points.

FIGS. 4A, 4B and 4C illustrate the manner in which a given compensation coefficient as a function of tone may be represented using respective linear, quadratic and cubic b-splines. Referring initially to FIG. 4A, an ideal curve 400 represents the complex sequence C_{n,m}(k) as determined from crosstalk estimates. Only the real parts of the complex sequence C_{n,m}(k) are shown for simplicity and clarity of illustration. The control points 402 are circled points on a linear spline curve 404 in which each value on curve 404 is represented as a weighted combination of its two nearest control points. For example, the points along the section of the curve 404 between control points 402-1 and 402-2 are each determined by linear interpolation between those two control points. It is important to note that the control points 402 in this example do not correspond to points on the ideal curve 400. Thus, the control points are not actual compensation coefficients from the complex sequence C_{n,m}(k). This is in contrast to conventional approaches, which involve interpolation between actual subsampled compensation coefficients.

In the FIG. 4A example, the compressed representations of the compensation coefficient as a function of tone may be stored by storing only the control points 402, which correspond to the endpoints of the linear segments of the linear spline curve 404. Alternatively, one can store an initial value and then a slope of each linear segment as control parameters. In either arrangement, the parameterized function ƒ(k,p) may be used to decompress the compressed representations to reconstruct the original compensation coefficients from the stored control points or control parameters.

An example of a quadratic spline representation of a particular compensation coefficient as a function of tone is shown in FIG. 4B. In this example, each value of the compensation coefficient that falls on the designated portion of the ideal curve 400 corresponding to tone range 406 between vertical lines 408-1 and 408-2 is represented as a combination of the three control points 412-1, 412-2 and 412-3. The dotted curve 415 illustrates the decompressed values that result by decompressing the compressed values that are each represented as a combination of three control points. It can be seen that the decompressed values very closely track the ideal curve 400.

An example of a cubic spline representation of a particular compensation coefficient as a function of tone is shown in FIG. 4C. In this example, each value of the compensation coefficient that falls on the designated portion of the ideal curve 400 corresponding to tone range 416 between vertical lines 418-1 and 418-2 is represented as a combination of the four control points 422-1, 422-2, 422-3 and 422-4. The dotted curve 430 illustrates the decompressed values that result by decompressing the compressed values that are each represented as a combination of four control points. Again, it can be seen that the decompressed values very closely track the ideal curve 400.

In the foregoing examples, a parameterized function ƒ(k,p) and associated control parameters p are selected and used to represent values of a compensation coefficient as a function of tone k. The process of generating such a representation is referred to herein as compression, and the process of reconstructing the original compensation coefficient from the representation is referred to as decompression. Thus, in these embodiments, a compressed representation of a given compensation coefficient for a particular tone k is generated by representing that compensation coefficient using the parameterized function of the plurality of control parameters. The given compensation coefficient for tone k can then be reconstructed by decompressing its compressed representation. This generally involves evaluating the parameterized function ƒ(k,p) using the particular subset of control parameters p associated with a given value of tone k.

Again, in these embodiments the control parameters need not correspond to any actual compensation coefficients, which is in contrast to conventional interpolation approaches. With conventional interpolation, the compression process is usually very simple, but the decompression process can be computationally intensive. For example, with conventional cubic spline interpolation, compression just involves discarding coefficients, while decompression requires solving a tri-diagonal linear system for the spline parameters, and then evaluating the resulting piecewise cubic functions. By contrast, for a well-designed parameterized function of the type described herein, the compression process may be computationally intensive, but the decompression process can be made very simple. This is advantageous because in many crosstalk control applications, the decompression is performed in real time much more frequently than the compression. As an example, in the above-described b-spline approach, compression is relatively complex, as linear least squares regression computations or other similar computations may be needed in order to find the optimal control points. However, decompression is very simple since one can reconstruct the coefficients by just applying pre-calculated weighted combinations of the stored control points.

It should be noted that although the compensation coefficient is expressed as a function of tone k in the foregoing examples, in other embodiments the compensation coefficient may more generally be expressed as a function of sub-channel index, where the sub-channels need not correspond to respective tones.

The manner in which the above-described compressed representations may be generated and utilized in a given multi-channel communication system such as the illustrative DSL system of FIGS. 2 and 3 will now be described with reference to the flow diagrams of FIGS. 5, 6 and 7. These flow diagrams show respective offline preparation, vector processing and offline update portions of a process for generation and utilization of compressed representations of compensation coefficients. The term “offline” in this context refers to processing that may occur prior to or subsequent to actual use of compensation coefficients to generate compensated signals in a precoder or postcoder.

Referring initially to FIG. 5, in step 500 the ideal compensation coefficients are determined for multiple sub-channels. This may involve, for example, determining the variation in each of a plurality of compensation coefficients as a function of tone, based on corresponding estimates of crosstalk. Such variation for a given compensation coefficient would often be expected to follow a smooth curve such as curve 400 of FIG. 4. Any of a wide variety of different techniques for determining crosstalk estimates and for determining compensation coefficients based on those crosstalk estimates may be used in a given embodiment. In step 502, control points are determined that optimally represent the desired compensation coefficients previously determined in step 500. As mentioned above, in the case of a b-spline parameterized function, this may involve performing linear least squares regression computations or other similar computations in order to find the optimal control points. Finally, in step 504, the control points are stored in a memory incorporated in, associated with, or otherwise accessible to the vector processor 315, such as memory 320. This memory may be viewed as an example of what is also referred to herein as “vector processor memory.”

The process illustrated in FIG. 5 may be viewed as an example of a compensation coefficient compression process as that term is utilized herein. The control points stored in step 504 along with the parameterized function represent the compensation coefficients in a compressed format.

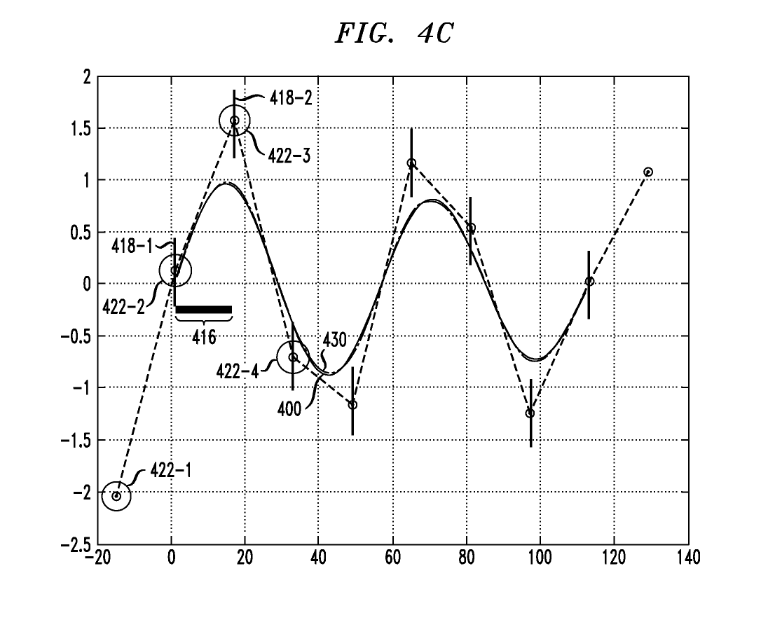

The flow diagram of FIG. 6 illustrates the manner in which the compressed representations are utilized in vector processing. In step 600, the control points associated with a given sub-channel are retrieved from memory. For linear, quadratic or cubic spline implementations, this will involve retrieval of two, three or four control points, respectively, for the given sub-channel. In step 602, the decompression function is applied to obtain a compensation coefficient for the given sub-channel. This generally involves evaluating the parameterized function using the retrieved control points. The compensation coefficient is then multiplied by a signal value in order to obtain a compensated signal value, as indicated in step 604.

In a typical arrangement, the same two, three, or four control points are reused for computing coefficients for a number (e.g., D) of adjacent sub-channels. For example, in the cubic spline case of FIG. 4C, the same four control points are used to compute all of the D coefficients in the range 416, with different weighting factors used for each tone. Advantageously, this means that the retrieving step 600 only needs to be done once for every D coefficients. Also, when moving to the next set of D coefficients, typically only one new control point is needed. For example, in the cubic spline case, one retrieves one new control point, discards one of the previous four control points, and retains three of the previous four control points. Thus, advantageously only one new control point needs to be retrieved from memory for each set of D coefficients.

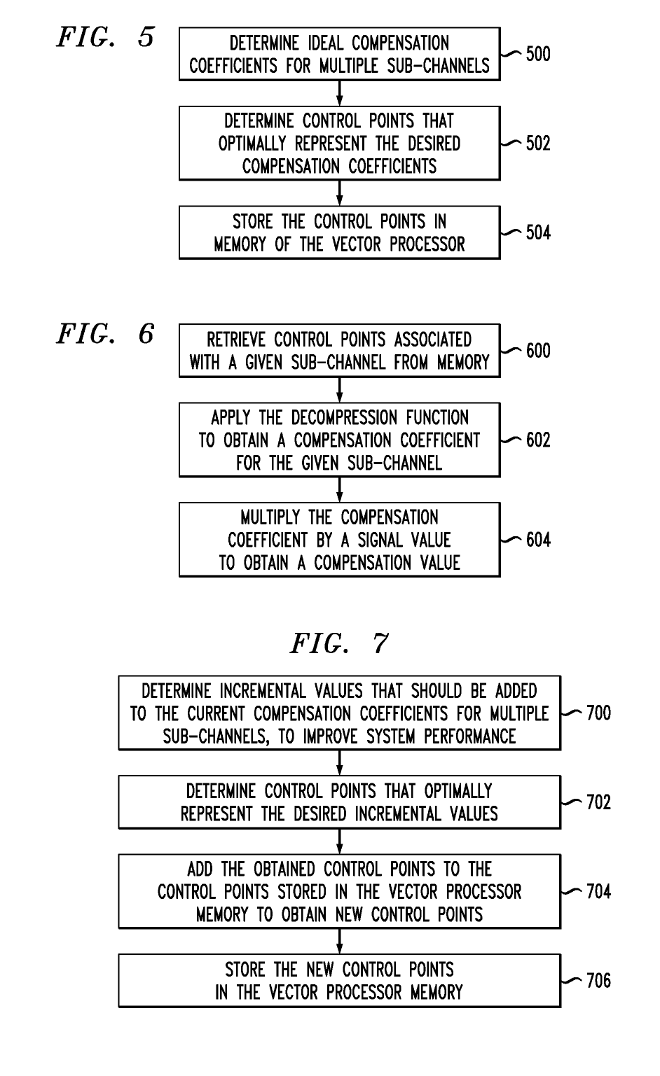

The compensation coefficients and control points can be incrementally updated using the offline process illustrated in FIG. 7. In step 700, incremental values are determined that should be added to the current compensation coefficients for multiple sub-channels, in order to improve system performance. Control points that optimally represent the desired incremental values are then determined in step 702. The incremental control points obtained in step 702 are added to the control points previously stored in the vector processor memory in order to obtain new control points, as indicated in step 704. In step 706, these new control points are stored in the vector processor memory.

It should be understood that the particular process steps shown in the flow diagrams of FIGS. 5, 6 and 7 are examples only, and other types of compression, decompression, compensation and update operations may be used in other embodiments. For example, the ordering of the steps may be varied, and certain steps may occur at least in part simultaneously with one another rather than sequentially as illustrated.

Advantageously, use of the compressed representations as described above significantly reduces the amount of the memory required for storage of compensation coefficients. Alternatively, for a given amount of available memory, use of the compressed representations allows one to represent the desired compensation coefficients more accurately. In crosstalk control applications, this can lead to improved signal-to-noise ratios and higher data rates. The parameterized function representation also can be configured to minimize the amount of computation required to reconstruct the coefficients from the stored parameters. This in general can allow vectored systems to be able to handle a larger number of lines or to be less expensive than they would otherwise be for a given number of lines.

It is to be appreciated that the exemplary compensation coefficient compression and decompression techniques described above are presented for purposes of illustration only, and should not be construed as limiting the scope of the invention in any way. Alternative embodiments may involve, for example, different types of sub-channels, coefficients, parameterized functions, and crosstalk control applications.

As a more particular example, alternative parameterized functions that may be used in embodiments of the invention include parameterized functions where a small number of parameters represent a coarse, global trend, and remaining parameters represent localized details. For example, two parameters, a slope and an intercept, could be used to represent a linear trend, and then remaining parameters could be used to represent the variations of the compensation coefficients above and below the linear trend. It is also possible in one or more embodiments to use multi-level hierarchical parameterized functions, such as wavelet bases, where parameters at a base level form a coarse description of the compensation coefficients, parameters at a first refinement level form a more detailed description of variations above and below the coarse description, and so on.

As indicated previously, the illustrative embodiments advantageously provide a substantial reduction in the processor and memory resources required for performing pre-compensation and post-compensation operations in vectored DSL systems, thereby permitting use of much larger groups of vectored lines than would otherwise be possible. Also, the required computation time per tone may be significantly reduced. DSL systems implementing the disclosed techniques may therefore exhibit reduced cost, lower power consumption, and enhanced throughput performance relative to conventional arrangements.

Embodiments of the present invention may be implemented at least in part in the form of one or more software programs that are stored in a memory or other processor-readable medium of AN 102 of system 100. Such programs may be retrieved and executed by a processor in the AN. The processor 115 may be viewed as an example of such a processor. Of course, numerous alternative arrangements of hardware, software or firmware in any combination may be utilized in implementing these and other systems elements in accordance with the invention. For example, embodiments of the present invention may be implemented in a DSL chip or other similar integrated circuit device. Thus, elements such as transceivers 208, VCE 210 and vectoring signal processing module 212 may be collectively implemented on a single integrated circuit, or using multiple integrated circuits. As another example, illustrative embodiments of the invention may be implemented using multiple line cards of a DSLAM or other access node. The term “vectoring circuitry” as used herein is intended to be broadly construed so as to encompass integrated circuits, line cards or other types of circuitry utilized in implementing operations associated with crosstalk cancellation in a communication system.

It should again be emphasized that the embodiments described above are presented by way of illustrative example only. Other embodiments may use different communication system configurations, AN and NT configurations, communication channels and sub-channels, or different types of compensation operations, depending on the needs of the particular communication application.

Alternative embodiments may therefore utilize the techniques described herein in other contexts in which it is desirable to provide improved crosstalk control between multiple channels of a communication system. By way of example, the disclosed techniques may be applied in wireless MIMO systems, such as a wireless MIMO system that comprises N mobiles and M transmit antennas at a base station, with each mobile equipped with a single antenna. The channel matrix in such a system may be estimated, for example, using pilots transmitted from the base station, with the pilot errors being reported back from the mobiles to the base station. The precoder matrix may be normalized so as to constrain the actual power used. In another possible implementation, one may process received pilots from the mobiles to determine an appropriate postcoder matrix.

It should also be understood that the particular assumptions made in the context of describing the illustrative embodiments should not be construed as requirements of the invention. The invention can be implemented in other embodiments in which these particular assumptions do not apply.

These and numerous other alternative embodiments within the scope of the appended claims will be readily apparent to those skilled in the art.

What is claimed is:

1. A method of controlling crosstalk between channels of a communication system, comprising:
determining estimates of crosstalk from one channel of the system into another channel of the system on multiple sub-channels;
determining compensation coefficients for respective ones of the multiple sub-channels based on the crosstalk estimates; and
generating compensated signals for respective ones of the multiple sub-channels based on the compensation coefficients;
wherein at least a given one of the compensation coefficients is determined for use in the generating step by decompressing a compressed representation of the given compensation coefficient;
wherein the compressed representation is decompressed by evaluating a parameterized function of a plurality of control parameters at least one of which does not correspond to any of the compensation coefficients.

2. The method of claim 1 wherein the sub-channels comprise respective tones of a DSL system.

3. The method of claim 1 further including the steps of:
determining the plurality of control parameters based on the compensation coefficients; and
storing the plurality of control parameters as at least a portion of said compressed representation.

4. The method of claim 1 wherein the parameterized function comprises a spline function and the control parameters comprise respective control points.

5. The method of claim 4 wherein the spline function comprises a linear spline function and the evaluating of the parameterized function to decompress the compressed representation of the given compensation coefficient is based on a combination of two control points.

6. The method of claim 4 wherein the spline function comprises a quadratic spline function and the evaluating of the parameterized function to decompress the compressed representation of the given compensation coefficient is based on a combination of three control points.

7. The method of claim 4 wherein the spline function comprises a cubic spline function and the evaluating of the parameterized function to decompress the compressed representation of the given compensation coefficient is based on a combination of four control points.

8. The method of claim 1 wherein the step of generating compensated signals based on the compensation coefficients comprises generating pre-compensated signals using corresponding elements of respective precoder matrices.

9. The method of claim 8 further comprising the step of transmitting the pre-compensated signals from an access node of system to respective network terminals of the system over respective ones of the channels.

10. The method of claim 1 wherein the step of generating compensated signals based on the compensation coefficients comprises generating post-compensated signals using corresponding elements of respective postcoder matrices.

11. The method of claim 10 further comprising the step of receiving uncompensated signals in an access node of the system from respective network terminals of the system over respective ones of the channels, wherein the post-compensated signals are generated from respective ones of the received uncompensated signals.

12. A non-transitory computer-readable storage medium having embodied therein executable program code that when executed by a processor of an access node of the system causes the access node to perform the steps of the method of claim 1.

13. An apparatus comprising:
an access node configured to control crosstalk between channels of communication system;
wherein the access node comprises:
a plurality of transceivers; and
vectoring circuitry coupled to the transceivers;
the vectoring circuitry comprising a processor coupled to a memory and being operative to determine estimates of crosstalk from one channel of the system into another channel of the system on multiple sub-channels, to determine compensation coefficients for respective ones of the multiple sub-channels based on the crosstalk estimates, and to generate compensated signals for respective ones of the multiple sub-channels based on the compensation coefficients;
wherein at least a given one of the compensation coefficients is determined for use in the generation of compensated signals by decompressing a compressed representation of the given compensation coefficient;
wherein the compressed representation is decompressed by evaluating a parameterized function of a plurality of control parameters at least one of which does not correspond to any of the compensation coefficients.

14. The apparatus of claim 13 wherein the vectoring circuitry comprises:
a vector control entity operative to estimate the crosstalk between the channels of the system and to generate the compensation coefficients; and
a vectoring signal processing module operative to generate the compensated signals based on the compensation coefficients.

15. The apparatus of claim 13 wherein the processor comprises a vector processor configured to generate the compensated signals.

16. The apparatus of claim 13 wherein the compensation coefficients comprise corresponding elements of a plurality of precoder matrices associated with respective ones of the multiple sub-channels.

17. The apparatus of claim 13 wherein the compensation coefficients comprise corresponding elements of a plurality of postcoder matrices associated with respective ones of the multiple sub-channels.

18. The apparatus of claim 15 wherein the vector processor is implemented in the form of a single integrated circuit.

19. A communication system comprising the apparatus of claim 13.

20. An integrated circuit comprising:
a vector processor operative to generate compensated signals based on compensation coefficients;
wherein at least a given one of the compensation coefficients is determined for use in the generation of compensated signals by decompressing a compressed representation of the given compensation coefficient; and
wherein the compressed representation is decompressed by evaluating a parameterized function of a plurality of control parameters at least one of which does not correspond to any of the compensation coefficients.
